(19) United States
(12) Patent Application Publication
(10) Pub. No.: US 2015/0173510 A1
(43) Pub. Date: Jun. 25, 2015

(54) SLIDE RAIL DEVICE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: MO-MING YU, Shenzhen (CN); XIANG-WEI HE, Shenzhen (CN)

(21) Appl. No.: 14/576,341

(22) Filed: Dec. 19, 2014

(30) Foreign Application Priority Data
Dec. 19, 2013 (CN) 201310699330.X

(51) Int. Cl. A47B 88/04; F16C 29/00

(52) U.S. Cl. CPC A47B 88/044; F16C 29/004

(57) ABSTRACT

A slide rail device is configured to be mounted to a pole defining a plurality of mounting holes. The slide rail device includes a slide rail, a bracket, a releasing member, and a latch member. The releasing member slides relative to the bracket in a first direction, the slide rail device is capable of being attached to the pole and the slide rail is capable of extending through the mounting hole; the releasing member slides relative to the bracket in a second direction to allow the slide rail to engage in the pole.

### FIELD

The subject matter herein generally relates to a slide rail device.

### BACKGROUND

Traditionally, a slide rail is used to connect two objects that can move relative to each other, such as a cabinet and a server. The slide rail is mounted between two poles of the cabinet by screws, which is inconvenient.

### BRIEF DESCRIPTION OF THE DRAWINGS

Implementations of the present technology will now be described, by way of example only, with reference to the attached figures.

FIG. 1 is an exploded, isometric view of an exemplary embodiment of a slide rail device.

FIG. 2 is similar to FIG. 1, but viewed from another angle.

FIG. 3 is an isometric view of a latch member of the slide rail device of FIG. 1.

FIG. 4 is an isometric view of a positioning member of the slide rail device of FIG. 1.

FIG. 5 is an assembled, isometric view of the slide rail device and a pole, wherein the slide rail device is in an unlocked state.

FIG. 6 is a partial view of FIG. 5, but viewed from another angle.

FIG. 7 is a cross-sectional view taken along the line VII-VII of FIG. 6.

FIG. 8 is similar to FIG. 5, wherein the slide rail device is in a locked state.

FIG. 9 is a partial view of FIG. 8, but viewed from another angle.

FIG. 10 is a cross-sectional view taken along the line X-X of FIG. 9.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

The present disclosure relates to a slide rail device.

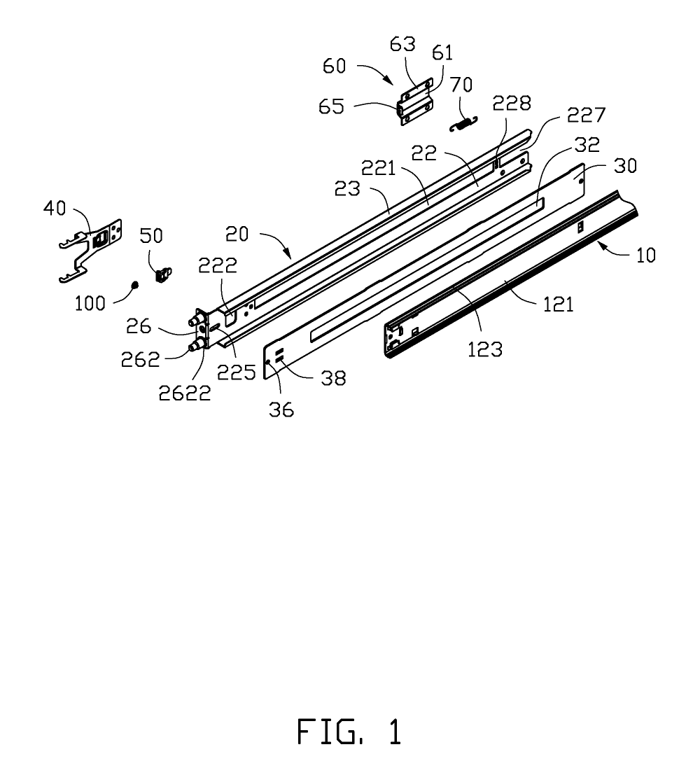

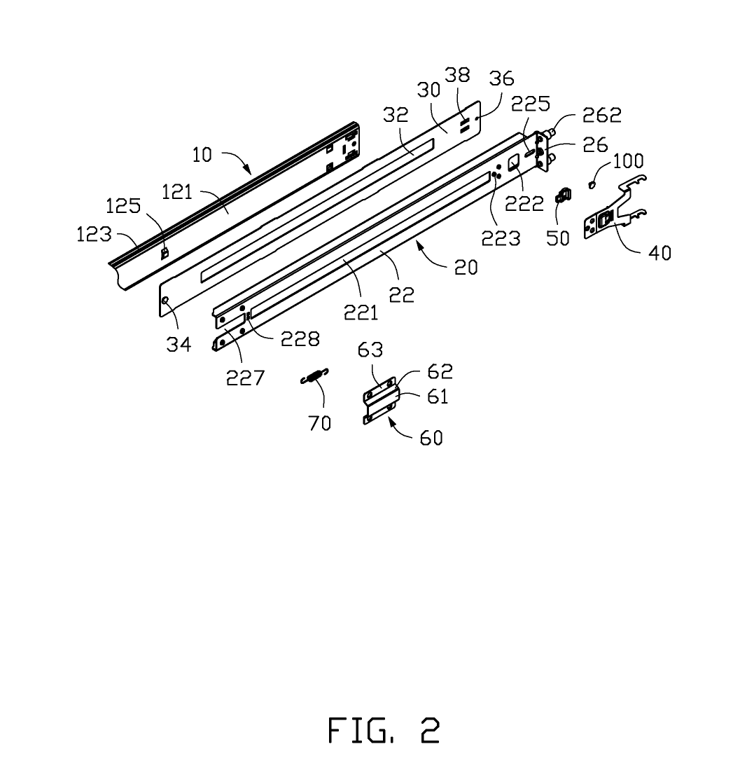

FIGS. 1, 2 and 5 illustrate an embodiment of the slide rail device is mounted to a pole 80 of a server cabinet. The pole 80 defines a plurality of mounting holes 82 in a vertical alignment. The slide rail device comprises a slide rail 10, a bracket 20, a releasing member 30, a latch member 40, a positioning member 50, a connecting member 60, and a resilient member 70. In the embodiment, the resilient member 70 is a coiled spring.

In the embodiment, the slide rail 10 comprises a base wall 121, two L-shaped flanges 123 extending inward from an upper edge and a lower edge of the base wall 121 in the same direction, and a block 125 protruding from an outside surface of the base wall 121.

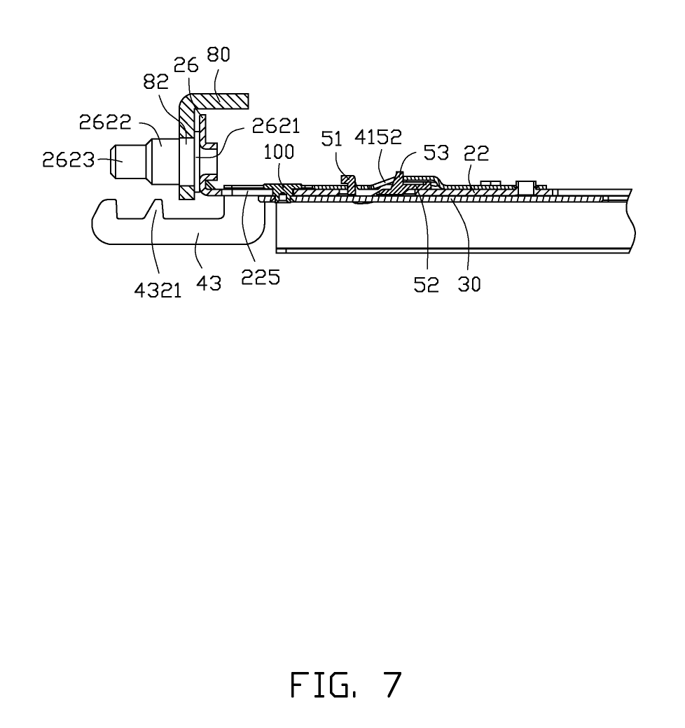

The bracket 20 comprises a base wall 22, two L-shaped flanges 23 respectively extending inward from an upper edge and a lower edge of the base wall 22 in the same direction, and an end plate 26 perpendicularly extending outward from a first end of the base wall 22. The base wall 22 defines a long groove 221 along a length, a slot 222 near the first end of the base wall 22 and a cutout 227 near a second end of the base wall 22 opposite to the first end. A plurality of pins 223 extends outward between the slot 222 and the groove 221. A channel 225 is defined in the base wall 22 between the slot 222 and the end plate 26. A fixing hole 228 is defined in the base wall 22 between the cutout 227 and the groove 221. Two posts 262 extend outward from the end plate 26. FIG. 7 illustrates that each post 262 comprises a rectangular tab 2621, a first cylindrical portion 2622 extending from the tab 2621, and a second cylindrical portion 2623 extending from the first portion 2622. The second cylindrical portion 2623 is thinner than the first cylindrical portion 2622. The first cylindrical portion 2622 and second cylindrical portion 2623 are configured for extending through the mounting holes 82 with different sizes.

The releasing member 30 is a long plate and comprises an opening 32 defined along a length, a fastening hole 36 defined in a first end, a pin 34 extending outward from a second end opposite to the first end, and a pair of locking holes 38 defined between the opening 32 and the fastening hole 36.

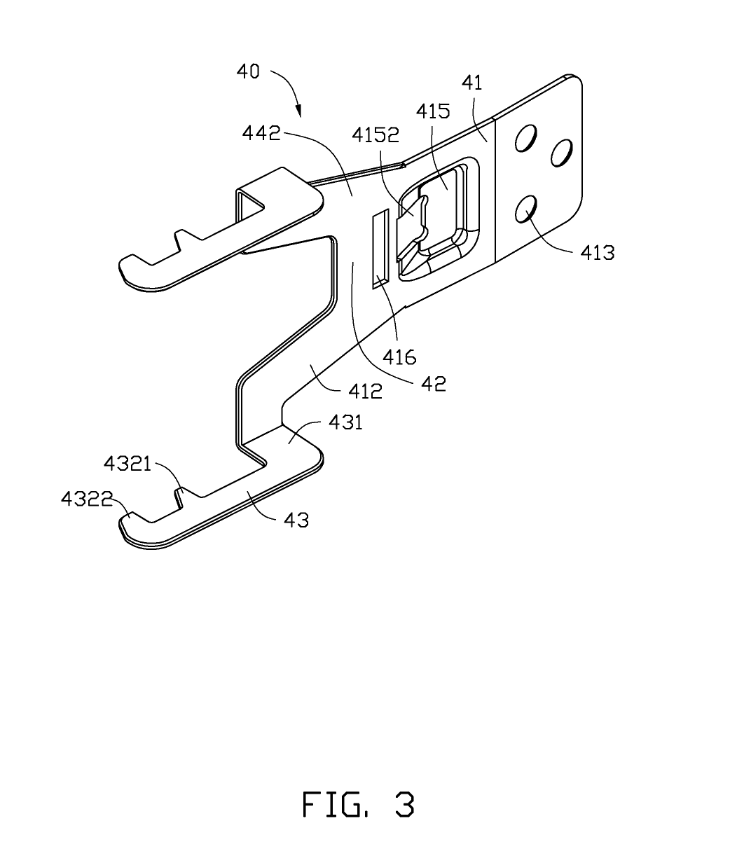

FIG. 3 illustrates the latch member 40. The latch member 40 is deformable and comprises a base sheet 41, a Y-shaped connecting sheet 42 slantingly extending from the base sheet 41, and a pair of catches 43 perpendicularly extending from an end of the connecting sheet 42 away from the base sheet 41. A plurality of mounting holes 413 is defined in the base sheet 41, a latching hole 416 is defined in the connecting sheet 42, and a recessed portion 415 is formed between the latching hole 416 and the mounting hole 413. A through hole 4152 is defined in the recessed portion 415 adjacent to the latching hole 416. Each catch 43 is general L-shaped and comprises a first tooth 4321 and a second tooth 4322 configured for latching pole 80 with different thickness.

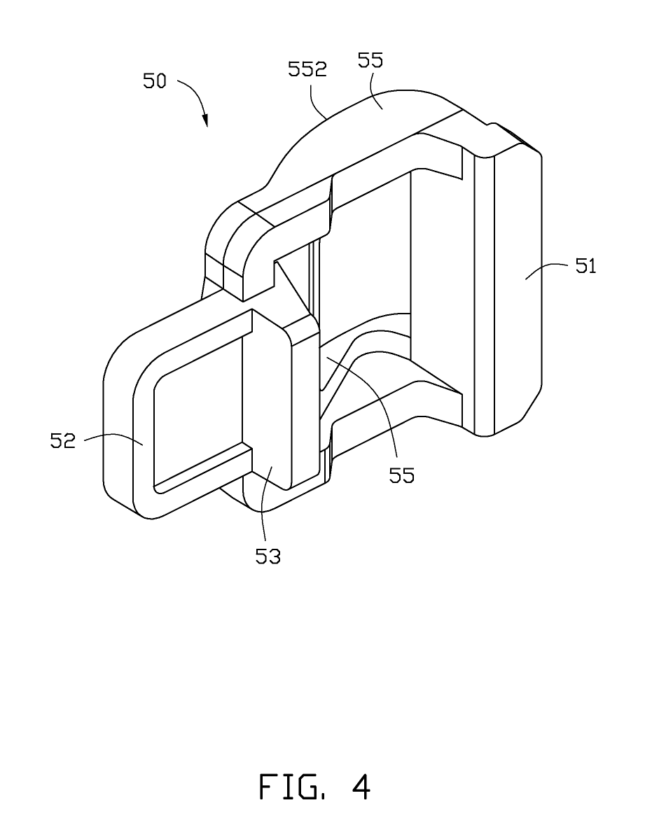

FIG. 4 illustrates the positioning member 50. The positioning member 50 comprises a hook 51 and an inserted block 53 extending from a first side of the positioning member 50, a pair of positioning blocks 55 extending from a second side of the positioning member 50 opposite to the first side. The positioning blocks 55 are located between the inserted block 53 and the hook 51. A frame 52 extends perpendicularly and outward from the inserted block 53. Each positioning block 55 comprises an arcuate end 552 away from the hook 51 and the inserted block 53.

The connecting member 60 comprises a base plate 61, two extending plates 62 extending from opposite side edges of the base plate 61, two fixing plates 63 extending from opposite side edges of the two extending plates 62 away from the base plate 61, and a connecting piece 65 perpendicularly extending from an end of the base plate 61 adjacent to the fixing plate 63.

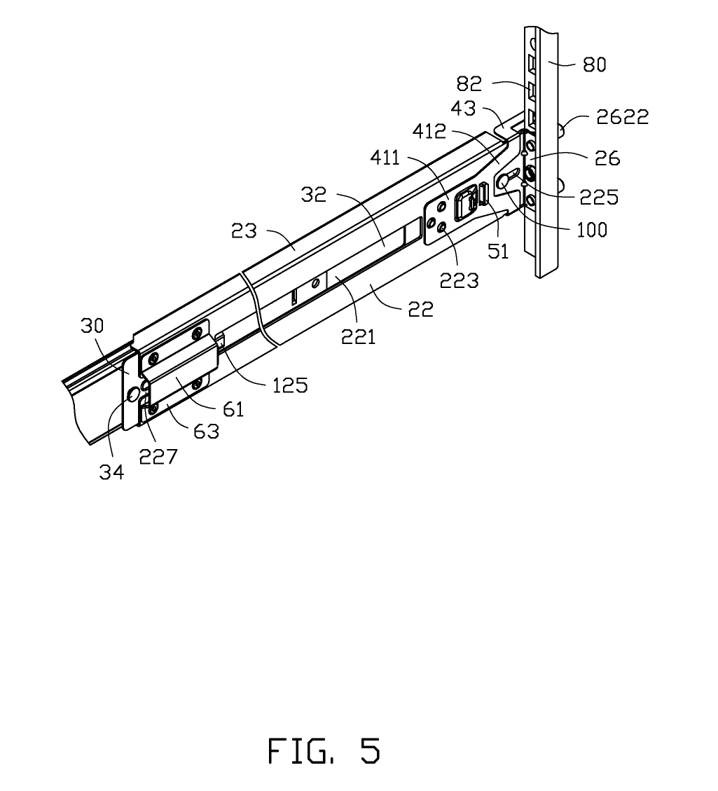

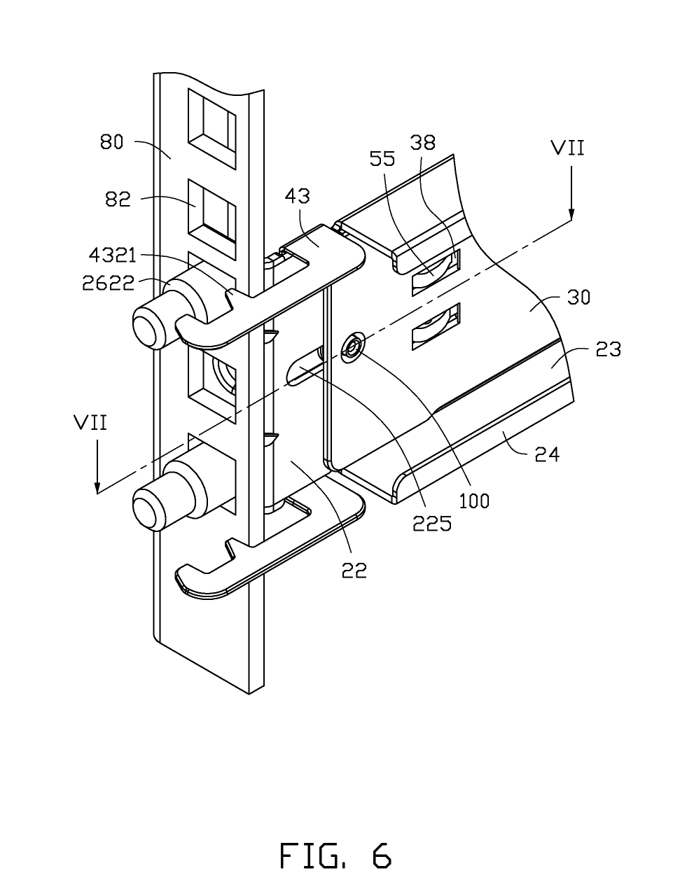

FIGS. 5, 6 and 7 illustrate when in assembly of the slide rail device, the releasing member 30 is attached to the inside of the base wall 22 of the bracket 20, with the pin 34 extending through the cutout 227 of the bracket 20 and a fastener 100 extending through channel 225 to engage in the fastening hole 36. The connecting member 60 is attached to an outside of the bracket 20 by fixing the fixing plates 63 to the base wall 22, with the connecting piece 65 extending through the fixing hole 228. Two opposite ends of the resilient member 70 are respectively coupled to the connecting piece 65 and the pin 34 of the releasing member 30. The positioning member 50 is attached to the latch member 40, with the hook 51 engaging in the latching hole 416, the inserted block 53 extending through the through hole 4152, and the frame 52 received in the recessed portion 415.

The latch member 40 and positioning member 50 are attached to the bracket 20. The positioning pins 223 of the bracket 20 are engaged by rivets in the mounting holes 413 of the latch member 40. The positioning blocks 55 of the positioning member 50 extend through the slot 222 of the bracket 20 to abut against the releasing member 30. The connecting sheet 42 and a portion of the base sheet 41 near the connecting sheet 42 are deformed to move away from the base wall 22 of the bracket 20 and the catches 43 accordingly move toward the base wall 22 of the bracket 20. The slide rail 10 is slid into the bracket 20 to slidably sandwich the releasing member 30 between the base wall 121 of the slide rail 10 and the base wall 22 of the bracket 20, the block 125 extends through the opening 32 of the releasing member 30 and the groove 221 of the base wall 22.

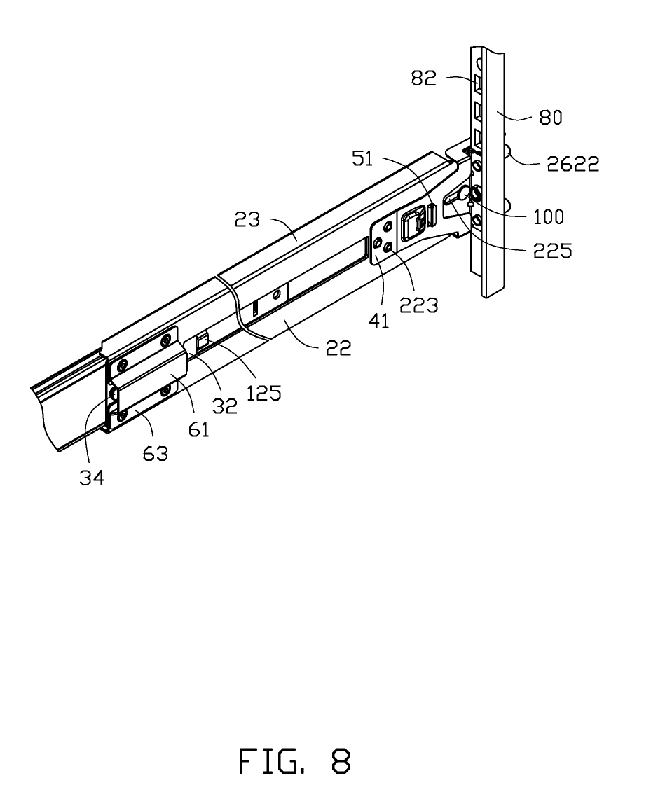

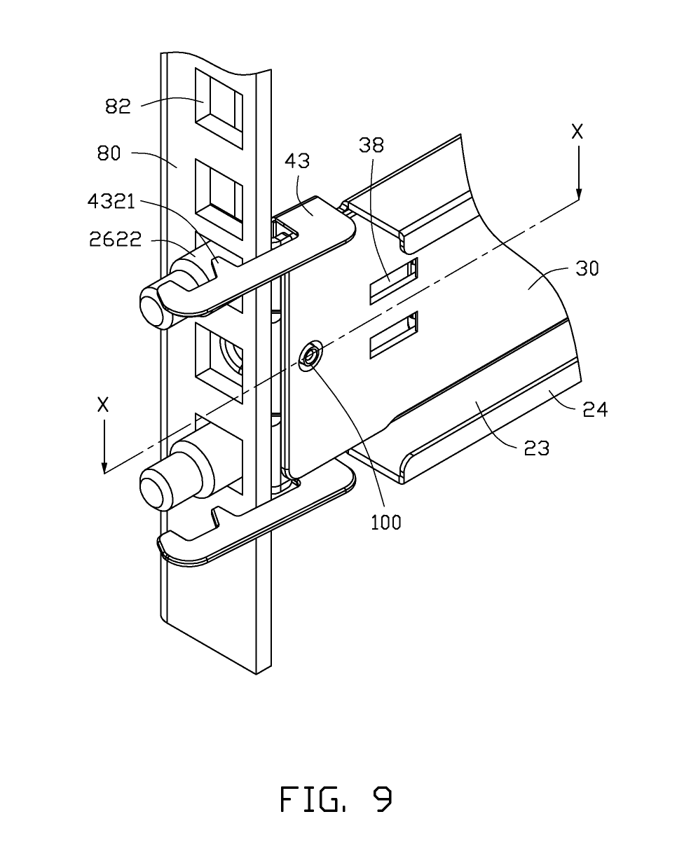

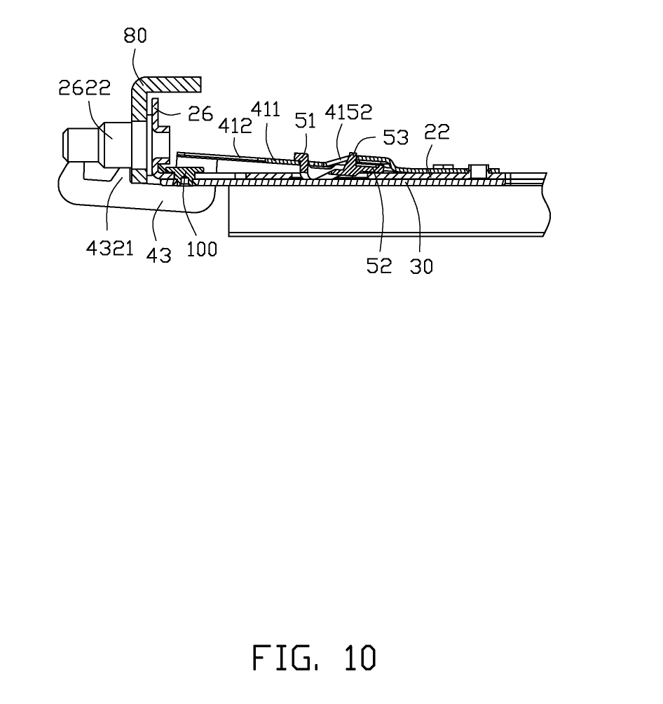

FIGS. 8, 9 and 10 illustrate when mounting the slide rail device to the pole 80, the bracket 20 is slid away from the slide rail 10 and toward the pole 80. The releasing member 30 is driven to slide accordingly by the resilient member 70. When an end of the opening 32 away from locking holes 38 is blocked by the block 125 of the slide rail 10, the releasing member 30 stops. The bracket 20 further slides relative to the slide rail 10 until the positioning blocks 55 of the resisting member 50 engage in the locking holes 38 of the releasing member 30. The resilient member 70 is deformed. The latch member 40 rebounds and the connection sheet 42 moves toward the base wall 22 of the bracket 20 and the catches 43 move away from the base wall 22 of the bracket 20. The posts 262 are capable of extending through the corresponding mounting holes 82 of the pole 80 until the two fixing tabs 2621 abut against one side of the pole 80 near the end plate 26. The pole 80 is situated between the end plate 26 and the first teeth 4321 of the latches 4321. Then, the slide rail 10 is slid toward the pole 80 relative to the bracket 20 and the block 125 moves away from the end of the groove 32. The resilient member 70 rebounds to drive the releasing member 30 to slide toward the pole 80. The releasing member 30 drives the positioning blocks 55 to withdraw from the locking hole 38, with the releasing member 30 slidably abutting against the arcuate end 552. The connection sheet 42 of the latch member 40 is deformed and the catches 43 accordingly move toward the base wall 22 of the bracket 20. The first teeth 4321 block one side of the pole 80 away from the end plate 26. The slide rail device is positioned to the pole 80.

To detach the slide rail device from the pole 80, the slide rail 10 slides away from the pole 80 relative to the bracket 20. The block 125 abuts against the end of the opening 32 to move the releasing member 30 away from the pole 80. When the two positioning blocks 55 descend into the locking holes 38 of the slide plate 30, the latch member 40 rebounds and the first teeth 4321 of catches 43 move away from the base wall 22 of the bracket 20. Thus, the slide rail device can be detached from the pole 80.

In another embodiment, the positioning member 50 and the connecting member 60 can be integrated.

In another embodiment, the latch member 40 can comprise one catch 43; the end plate 26 can comprise one inserted post 262 to engage with the catch arm 43.

In another embodiment, the connecting member 60 can be integrated with the bracket 20.

The embodiments shown and described above are only examples. Many details are often found in the art such as the other features of a slide rail device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A slide rail device assembly comprising:
a pole defining a plurality of mounting holes; and
a slide rail device coupled to the pole and comprising:
a slide rail;
a bracket comprising an end plate formed at a first end of the bracket; and a post extending from the end plate;
a releasing member slidably coupled between the slide rail and the bracket, and defining a locking hole; and
a deformable latch member mounted to the bracket and comprising a catch and a positioning block, the positioning block configured for detachably extending through the locking hole of the releasing member; and
wherein the releasing member is configured to slide relative to the bracket in a first direction to allow the positioning block to withdraw from the locking hole and abut against the releasing member; the latch member is configured to deform to allow the catch to move away from the bracket; the slide rail device is configured to be attached to the pole; the post is configured to extend through the mounting hole of the pole; the releasing member is configured to slide relative to the bracket in a second direction opposite to the first direction to allow the positioning block to engage in the locking hole, whereby the latch member rebounds to drive the catch to move toward the bracket to block the pole to latch the slide rail device to the pole.

2. The slide rail device assembly of claim 1, further comprising a positioning member attached to the latch member, wherein the positioning block is formed at the positioning member, the bracket defines a slot for the positioning block extending there through.

3. The slide rail device assembly of claim 2, wherein the positioning block comprises an arcuate end to engage with the releasing member.

4. The slide rail device assembly of claim 2, wherein the latch member comprises a base sheet fixed to the bracket, and a connecting sheet slantingly extending from the base sheet, the catch perpendicularly extends from the connecting sheet, the connecting sheet defines a latching hole therein, the positioning member comprises a hook engaged in the latching hole.

5. The slide rail device assembly of claim 4, wherein the latch member comprises a recessed portion formed between the base sheet and the connecting sheet to hold the positioning member therein, the recessed portion defines a through hole, the positioning member further comprises an inserted block extending through the through hole.

6. The slide rail device assembly of claim 1, further comprising a resilient member coupled between the bracket and the releasing member, wherein the bracket defines a cutout in a second end thereof opposite to the first end, the releasing member comprises a pin extending through the cutout, a connecting member is mounted to the bracket and comprises a connecting piece, opposite ends of the resilient are coupled to the mounting pin and the connecting piece.

7. The slide rail device assembly of claim 6, wherein the connecting member comprises a base plate, two extending plates slantingly extending from opposite sides of the base plate, and two fixing plates respectively extending from the opposite sides of the two extending plates, the fixing plates are fixed to the bracket, the connecting piece is extending from an end of the base plate.

8. The slide rail device assembly of claim 1, wherein the bracket defines a channel along a length thereof, the releasing member defines a fastening hole thereof, a fastener extends through the channel to engage in the fastening hole.

9. The slide rail device assembly of claim 1, wherein the bracket defines a groove along a length thereof, the releasing member defines a opening along a length thereof, a block extend from the slide rail to slidably extend through the groove of the bracket and the opening of the releasing member.

10. A slide rail device comprising:
a slide rail comprises a block extending therefrom;
a bracket comprising an end plate formed at a first end of the bracket, and a post extending from the end plate;
a releasing member slidably coupled between the slide rail and the bracket, defining a locking hole; and
a deformable latch member mounted to the bracket and comprising a catch and a positioning block, the positioning block configured for detachably extending through the locking hole of the releasing member; and
wherein the releasing member is configured to slide relative to the bracket in a first direction to allow the positioning block to withdraw from the locking hole and against the releasing member; the latch member is configured to deform to allow the catch to move away from the bracket, the releasing member is configured to slide relative to the bracket in a second direction opposite to the first direction to allow the positioning block to engage in the locking hole, the latch member rebounds to drive the catch to move toward the bracket.

11. The slide rail device of claim 10 further comprising a positioning member attached to the latch member, wherein the positioning block is formed at the positioning member, the bracket defines a slot for the positioning block extending there through.

12. The slide rail device of claim 10, wherein the latch member comprises a base sheet fixed to the bracket, and a connecting sheet slantingly extending from the base sheet, the latch perpendicularly extends from the connecting sheet, the connecting sheet defines a latching hole therein, the positioning member comprises a hook engaged in the latching hole.

13. The slide rail device of claim 12, wherein the latch member comprises a recessed portion formed between the base sheet and the connecting sheet to hold the positioning member therein, the recessed portion defines a through hole, the positioning member further comprises an inserted block extending through the through hole.

14. The slide rail device of claim 10, further comprising a resilient member coupled between the bracket and the releasing member, wherein the bracket defines a cutout in a second end thereof opposite to the first end, the releasing member comprises a pin extending through the cutout, a connecting member is mounted to the bracket and comprises a connecting piece, opposite ends of the resilient are coupled to the mounting pin and the connecting piece.

15. The slide rail device of claim 10, wherein the bracket defines a groove along a length thereof, the releasing member defines a opening along a length thereof, a block extend from the slide rail to slidably extend through the groove of the bracket and the opening of the releasing member.
